(19) United States
(12) Patent Application Publication
(10) Pub. No.: US 2014/0305117 A1
(43) Pub. Date: Oct. 16, 2014

(54) POWER CYLINDER AND CONSTRUCTION MACHINE OR LIFTING GEAR

(71) Applicant: Liebherr-Hydraulikbagger GmbH, Kirchdorf/lller (DE)

(72) Inventor: Roman Hofmann, Wangen (DE)

(73) Assignee: Liebherr-Hydraulikbagger GmbH, Kirchdorf/lller (DE)

(21) Appl. No.: 14/249,599

(22) Filed: Apr. 10, 2014

(30) Foreign Application Priority Data
Apr. 11, 2013 (DE) 10 2013 006 231.4

(51) Int. Cl. F15B 21/08; E02F 3/42; F15B 13/044; E02F 9/22

(52) U.S. Cl. CPC F15B 21/085; E02F 9/22; E02F 3/42; F15B 13/044; E02F 9/2228
USPC 60/463; 60/459

(57) ABSTRACT

The invention relates to a power cylinder comprising a piston-in-cylinder unit having at least one pressure connection, an integral valve arrangement for controlling the pressure volume flow from the pressure connection into the cylinder space and an integrated control and/or regulation unit for actuating the valve arrangement.

The invention relates to a power cylinder comprising a piston-in-cylinder unit. The invention furthermore comprises a construction machine or lifting gear having such a power cylinder.

Known power cylinders serve as a drive unit for carrying out linear movements. A distinction is made between cylinders with a single action and cylinders with a double action. A linear movement of the piston rod is achieved by pressure application on one or more active surfaces. The piston movement is taken up via the piston rod and transferred to the machine components to be moved.

The volume flow or pressure required for the linear movement is provided and adjusted by an external regulation circuit. The volume flow adaptation or pressure adaptation takes place in a hydraulic manner via hydraulic components of the external regulation circuit. The cylinders known from the prior art consequently provide one or more pressure connections via which the volume flow generated via the external regulation circuit is provided to the respective active surface of the cylinder.

As the automation of construction machines proceeds, the demands on the installed machine components increase. In this connection, there is an increased demand for intelligent cylinders which are characterized by a regulated movement.

It is the object of the present invention to further develop power cylinders of the category to adapt them to the required conditions of automation engineering.

This object is satisfied by a power cylinder in accordance with the features of claim 1. Advantageous embodiments of the power cylinder are the subject of the dependent claims.

In accordance with claim 1, a power cylinder is proposed which comprises a piston-in-cylinder unit in the customary manner. The power cylinder comprises at least one pressure connection for providing a volume flow or pressure energy for the operation of the power cylinder. The power cylinder further comprises an integral valve arrangement for regulating/controlling the infeed of the pressure volume flow provided via the at least one pressure connection into the cylinder space. An integrated control and/or regulation unit is provided for an autonomous control/regulation of the piston rod movement of the power cylinder which is connected to the valve arrangement and carries out a corresponding control of the valve arrangement.

Accordingly a kind of intelligent power cylinder is provided which controls or regulates its position and its kinematic behavior automatically. No external components are required for this purpose, but the cylinder rather only makes use of its own components. Only pressure energy is provided to the cylinder, for example in the form of a constant pressure volume flow. The required application of pressure to the one or more active surfaces of the piston-in-cylinder unit is determined and carried out independently.

The cylinder type and the construction design of the working principle are less relevant for the core idea of the invention. The power cylinder can, for example, be configured as a hydraulic cylinder or pneumatic cylinder. The power cylinder can furthermore be designed as a single action or double action hydraulic cylinder. The presented idea in accordance with the invention can be transferred without restriction to telescopic cylinders.

In a preferred embodiment, the valve arrangement comprises at least one valve per active surface which can be regulated and which can be activated accordingly via the control and/or regulation unit to apply the desired pressure to the associated active surface. The one or more valves which can be regulated are connected at the inlet side to the at least one pressure connection and at the outlet side to at least one opening to the cylinder space, in particular to an opening to the cylinder space having the active surface associated with the valve.

Electrically controllable proportional valves are particularly suitable which are electrically connected to the control and/or regulation unit and receive corresponding switch signals from it. The one or more valves are sensibly at least partly embedded into the cylinder jacket. This is not only space-saving, but also protects the valve from external influences.

In a preferred embodiment, a valve is directly connected to the pressure connection, while one or more further valves are connected to the pressure connection via a pressure line of the power cylinder. The pressure line can extend at least partly through the cylinder jacket in the manner of a passage.

At least one data interface is preferably provided for the communication link of the power cylinder to external. Suitable control or regulation parameters or any other commands or information for the position control of the cylinder or for the influencing of the working/movement behavior of the cylinder can be supplied to the control and/or regulation unit via the data interface.

Alternatively or additionally, the data interface can be suitable for data retrieval. In this respect, certain control and/or regulation parameters of the power cylinder or any other information of the power cylinder relevant to operation can be read out through an external, higher-ranking control. For example, regulation measured data and/or position measured data and/or dynamic measured data can be provided by the control and/or regulation unit via the integrated data interface. It is not only possible to draw a conclusion on the current position of the piston rod using these measured data, but information can rather additionally be retrieved such as the current energy requirement.

An integral position measurement system is expediently arranged at or in the cylinder for the position determination of the piston rod and communicates with the control and/or regulation unit. The position measurement system can preferably be arranged at the end-face cylinder surface in the region of the piston rod output. The current position of the piston rod relative to the cylinder housing can be detected via the integrated measurement system. The detection of the current movement speed of the piston is also possible.

It is conceivable that the power cylinder has a storage means for storing control or regulation parameters relevant to operation and which the control or regulation unit can make use of during cylinder operation. It is also conceivable that one or more control or regulation profiles can be stored in the storage means. Such profiles describe different control or regulation behavior of the power cylinder, for example for different use purposes. The desired cylinder behavior can be configured by selection of the suitable profile in dependence on the application. The profile types can preferably differ with respect to the resulting working speed of the linear movement. It can furthermore be laid down in the profile whether a load damping should be realized by a direct control of the valve arrangement. It is pointed out in this connection that the implementation of load damping can be realized without additional components by modification of the executed regulation algorithm of the control and/or regulation unit.

The use of profiles allows a simple implementation and realization of different kinds of cylinder types each having different working behaviors which can therefore be flexibly adapted to various areas of use. A universal power cylinder is therefore provided for a hugely wide portfolio by the invention.

Provision can be made for the programming of the power cylinder that the storage means can be addressed via the data interface. In this manner, existing regulation or control parameters or regulation profiles can be prepared, modified, deleted or read out. Alternatively or additionally, provision can equally be made that the control and regulation unit can be actuated directly via the data interface and receives the required profile(s) or parameter(s) directly via the interface.

In a further advantageous embodiment, the control and/or regulation unit can be suitable for the execution of one or more monitoring functions. The control and/or regulation unit for example comprises an implemented logic for executing a test run for checking the basic cylinder operation. Additionally or alternatively, specific test routines can be available for recognizing damage, in particular leaks within the power cylinder. Furthermore a program can optionally be available for determining the quality of the pressure medium used, for example for detecting the fluid quality of the used hydraulic medium for the carrying out.

The invention moreover relates to a construction machine, in particular an excavator, or a lifting gear having at least one power cylinder in accordance with the present invention or with an advantageous embodiment of the invention. The construction machine or the lifting gear obviously has the same advantages and properties as the power cylinder in accordance with the invention so that a repeat description will be dispensed with at this point.

The at least one power cylinder is connected via a pressure connection to a pressure circuit of the construction machine or lifting gear in accordance with the invention. A central control unit of the construction machine or of the lifting gear is connected via the data interface of the power cylinder in accordance with the invention to its control and regulation unit. The operation of the power cylinder can be influenced and checked by the higher ranking control via the data interface. In addition, the interface offers the option of retrieving and centrally evaluating current state information relating to the power cylinder. The control and/or regulation of the piston movement is, however, the responsibility of each power cylinder.

Further advantages and particulars of the invention will be explained in detail with reference to an embodiment shown in the drawing. There are shown:

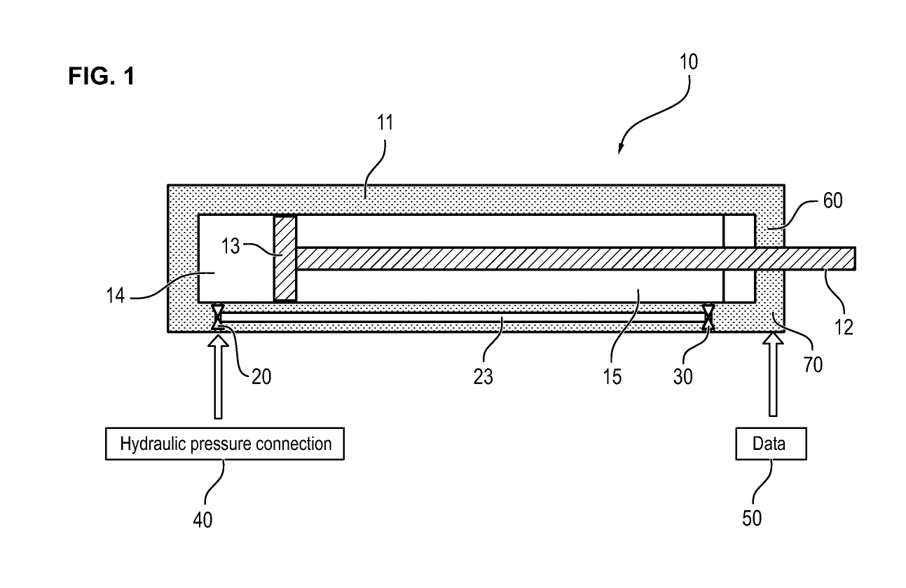

FIG. 1 a system diagram of the power cylinder in accordance with the invention; and

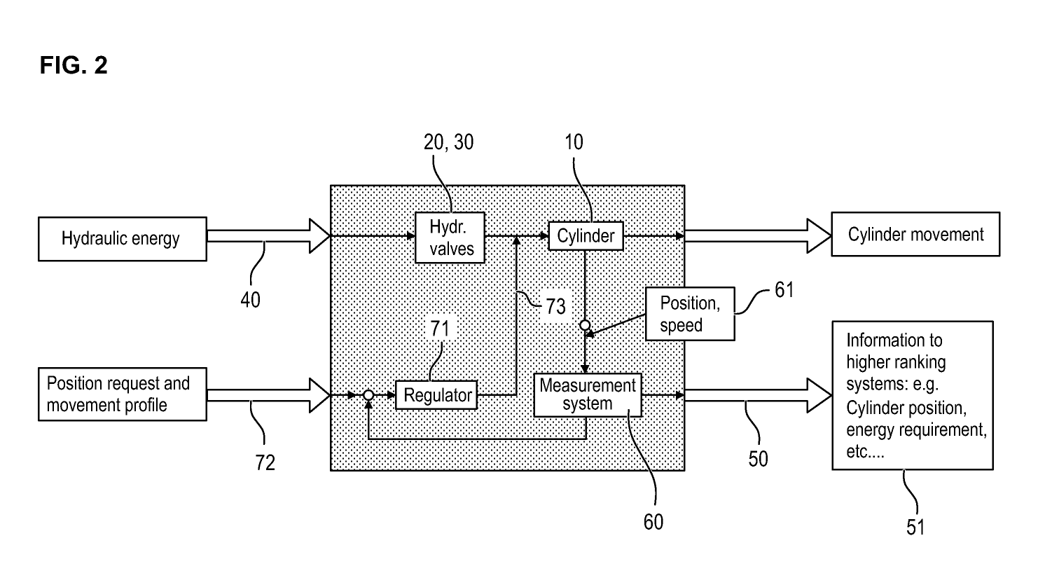

FIG. 2: a functional diagram of the power cylinder in accordance with the invention of FIG. 1.

The idea material to the invention of an intelligent power cylinder will be explained using the double-action linear cylinder 10 shown in FIG. 1. It is, however, obvious that the teaching in accordance with the invention can be used with a plurality of different cylinder types and is not restricted to the specific embodiment of FIGS. 1 and 2.

FIG. 1 shows a power cylinder 10 having a cylinder jacket 11 and a piston rod 12 supported linearly displaceably therein. The piston 13 is arranged at the end of the piston rod 12 disposed within the cylinder space. The other piston rod end exits the cylinder space through the end face of the cylinder jacket 11.

Due to the double-action operation of the power cylinder 10, the cylinder space is divided into two cylinder spaces sealed with respect to one another, namely the cylinder space 14 at the piston side and the cylinder space 15 at the rod side. A linear movement of the piston rod 12 can be produced by a direct pressure regulation of the pressure level within the cylinder spaces 14, 15.

A valve arrangement of two proportional valves 20, 30 which can be regulated is embedded into the cylinder jacket 11. The regulation valve 20 regulates the pressure level present in the cylinder space 14, while the proportional valve 30 determines the pressure level within the cylinder space 15. The cylinder 10 is operated using a hydraulic medium. The valves 20, 30 are connected to a central hydraulic pressure connection 40, with the valve 30 being connected in a fluid-conducting manner to the pressure connection 40 via a passage 23 provided in the cylinder jacket 11. The chamber pressure can be set and the desired piston movement produced by the regulation of the volume flow into the respective chambers 14, 15 by means of the associated valves 20, 30.

The actuation of the proportional valves 20, 30 takes place electrically. Suitable control signals are produced and applied to the respective control input of the valves 20, 30 by a control and regulation unit 70 which is likewise an integral component of the power cylinder 10. The unit 70 is arranged at the end of the cylinder jacket 11 at the piston rod side. A measurement device 60 likewise fastened to the cylinder jacket 11 in the region of the piston rod output measures the movement speed of the piston in addition to the current position of the piston rod 12 relative to the cylinder housing 11 and communicates both values to the control and/or regulation unit. The measurement unit 60 is based on the developed positioning sensor system for hydraulic cylinders PMHC.

A data interface 50 is available for data exchange and serves the communication of the control and/or regulation unit with a higher ranking central control. In addition, the basic programming or maintenance of the power cylinder 10, in particular of the control and regulation unit 70, can take place via the data interface.

The basic operation of the power cylinder 10 in accordance with the invention will be illustrated with reference to the functional sketch of FIG. 2. The power cylinder is provided with a constant hydraulic energy via the hydraulic pressure connection 40. The hydraulic energy is applied to both proportional valves 20, 30 at the inlet side. The passage of the two hydraulic valves 20, 30 is determined and set at the valves 20, 30 by the regulator 71 of the control and regulation unit 70.

The regulator 71 receives a possible position request or a movement profile as a desired parameter 72. The desired parameter 72 is compared with the actual value 61 and a corresponding setting value 73 for the hydraulic valves 20, 30 is generated therefrom. The actual value 61 is provided by the measurement system 60 and characterizes the current position of the piston rod 12. In addition or alternatively, further values provided via the measurement system such as the speed of the piston movement can be taken and used as the actual value 61.

The current position request of the power cylinder 10 as well as a possible movement profile can be stored in a memory unit, not shown, with access through the control and regulation unit 70 or can be provided alternatively to the running time via the data interface 50. A desirable working behavior of the power cylinder 10 can be configured via the movement profile. This includes, on the one hand, the desired movement speed of the piston rod 12 and the realization of an end position damping, etc.

The control parameter 73 generated by the regulator 71 is applied to the valves 20, 30 as an electrical control signal to set the desired pressure level in the cylinder chambers 14, 15.

In addition, information 51 can be transmitted to a higher ranking system via the data interface 50. This includes, for example, the current cylinder position and the energy requirement of the power cylinder 10 needed for the operation.

The control and regulation unit 70 can moreover comprise a logic for possible monitoring functions of the power cylinder 10. This includes, for example, a monitoring function for checking the basic functions of the power cylinder 10 as well as for recognizing possible damage or leaks within the cylinder system. The control and regulation unit 70 can nevertheless comprise a logic for checking the current fluid quality of the hydraulic oil used.

The invention describes an integrated intelligent cylinder which receives the position and the kinematic behavior in the form of digital data. Hydraulic energy is available to the cylinder; however, it regulates the necessary energy requirements and its movement independently in dependence on provided regulation parameters or predefined profiles. Furthermore, it can provide regulation measurement data, position measurement data and dynamic measurement data to higher ranking systems, whereby a process automation or partial automation as well as a monitoring function can be represented.

The behavior of the hydraulic cylinder can be understood analog to electrically controlled or regulated actuator drives and can be interpreted as a closed system to which only energy has to be supplied and via whose data interface the communication with a higher ranking control system can take place.

The power cylinder in accordance with the invention provides competitive conditions for the automation of work processes or assistance systems. The cylinder thus provides the necessary conditions for the realization of a breakdown torque control, for example for protection in load lifting work or for a stroke restriction, with here different power cylinders being able to be used for different equipment. A speed control which in particular allows lower speeds, in particular in the danger zone, i.e. dependent on position, can be introduced particularly simply by the electrical control. In addition, a load damping, for example for damping the equipment with respect to rocking, can be realized without any additional construction effort. This electronic end position damping effects an omission of the otherwise required mechanism. The adaptation of the working behavior to certain application areas equally takes place purely electronically and not, as previously, hydraulically.

The invention therefore provides a universal hydraulic cylinder, whereby a reduction of the total portfolio of cylinders can be achieved. In addition, a required customization can be implemented particularly simply via the electronic control. Furthermore, many self-monitoring functions and diagnostic functions are available within the cylinder through the electronics.

An improved energy efficiency is provided overall by a predictable hydraulic energy requirements, which can be regulated, whereby required conditions for the pump regulation are satisfied.

1. A power cylinder comprising a piston-in-cylinder unit having at least one pressure connection, an integral valve arrangement for controlling the pressure volume flow from the pressure connection into the cylinder space and an integrated control and/or regulation unit for actuating the valve arrangement.

2. A power cylinder in accordance with claim 1, wherein the valve arrangement comprises at least one valve which can be regulated, in particular an electrically controllable proportional valve, per active surface.

3. A power cylinder in accordance with claim 2, wherein two or more valves are arranged at least partially within the cylinder jacket, with them preferably being connected to one another via at least one pressure passage extending in the cylinder jacket.

4. A power cylinder in accordance with claim 1, wherein the control and/or regulation unit comprises a data connection.

5. A power cylinder in accordance with claim 4, wherein regulation measurement data, and/or position measurement data and/or dynamic measurement data can be provided by the control and/or regulation unit via the data interface.

6. A power cylinder in accordance with claim 1, wherein an integral position measurement system is provided at the cylinder and is in communication connection with the control and/or regulation unit.

7. A power cylinder in accordance with claim 1, wherein the valve arrangement can be controlled/regulated by the control and/or regulation unit in dependence on a movement profile and/or one or more regulation parameters, with the movement profile and/or the regulation parameters being able to be provided by an integrated memory means of the power cylinder and/or via the data interface.

8. A power cylinder in accordance with claim 1, wherein one or more monitoring functions can be executed by means of the control and/or regulation unit, in particular for monitoring the cylinder operability and/or for recognizing damage or leaks in the power cylinder and/or for detecting the quality of the used pressure medium, in particular hydraulic fluid.

9. A power cylinder in accordance with claim 1, wherein the power cylinder is a pneumatic or hydraulic cylinder.

10. A power cylinder in accordance with claim 1, wherein the power cylinder is a single-action or double-action cylinder or a telescopic cylinder.

11. A construction machine, in particular an earthmover or a lifting gear having at least one power cylinder in accordance with claim 1.

12. A power cylinder in accordance with claim 3, wherein the control and/or regulation unit comprises a data connection.

13. A power cylinder in accordance with claim 2, wherein the control and/or regulation unit comprises a data connection.

14. A power cylinder in accordance with claim 13, wherein regulation measurement data, and/or position measurement data and/or dynamic measurement data can be provided by the control and/or regulation unit via the data interface.

15. A power cylinder in accordance with claim 12, wherein regulation measurement data, and/or position measurement data and/or dynamic measurement data can be provided by the control and/or regulation unit via the data interface.

16. A power cylinder in accordance with claim 15, wherein an integral position measurement system is provided at the cylinder and is in communication connection with the control and/or regulation unit.

17. A power cylinder in accordance with claim 14, wherein an integral position measurement system is provided at the cylinder and is in communication connection with the control and/or regulation unit.

18. A power cylinder in accordance with claim 13, wherein an integral position measurement system is provided at the cylinder and is in communication connection with the control and/or regulation unit.

19. A power cylinder in accordance with claim 12, wherein an integral position measurement system is provided at the cylinder and is in communication connection with the control and/or regulation unit.

20. A power cylinder in accordance with claim 5, wherein an integral position measurement system is provided at the cylinder and is in communication connection with the control and/or regulation unit.
